(19) United States
(12) Patent Application Publication
(10) Pub. No.: US 2014/0182256 A1
(43) Pub. Date: Jul. 3, 2014

(54) DEVICE FOR MOWING

(71) Applicants: Mats Fischier, Båstad (SE); Sture Larsson, Veberöd (SE)

(72) Inventors: Mats Fischier, Båstad (SE); Sture Larsson, Veberöd (SE)

(73) Assignee: MATS FISCHIER I BÅSTAD AB, Bästad (SE)

(21) Appl. No.: 14/131,383

(22) PCT Filed: Jun. 28, 2012
(86) PCT No.: PCT/SE2012/050732

§ 371 Date: Mar. 5, 2014

(30) Foreign Application Priority Data
Jul. 8, 2011 (SE) 1150645-8

(51) Int. Cl. A01D 34/52

(52) U.S. Cl. CPC A01D 34/52
USPC 56/256

(57) ABSTRACT

A device for mowing, comprising a rotatable shaft (6) and a plurality of supporting structures (7) arranged along the shaft (6), each of which structures supports a plurality of circumferentially arranged and radially extending blades (8), each of which blades exhibits a radially extending blade edge (9) which extends to the free blade end (10) and which, on rotation of the aforementioned shaft (6), are arranged for mowing. Each blade edge (9) is angled in relation to a blade plane extending perpendicularly in relation to the aforementioned shaft (6) at an angle (a) of less than 45°, and the free blade ends (10) of the blades (8) in each of the aforementioned supporting structures (7) are distributed between at least three blade positions (KP) that are mutually separated in the axial direction.

### TECHNICAL FIELD

The present invention relates to a device for mowing, and more precisely a device of a kind which comprises a rotatable shaft and a plurality of supporting structures arranged along the shaft, each of which supports a plurality of circumferentially distributed and radially extending blades.

### BACKGROUND ART

There is a large number of different types of devices for mowing, which are also referred to as lawn mowers.

A first type is normally referred to as a cylinder lawn mower. A lawn mower of this kind usually comprises a cylinder device with a plurality of peripherally supported blades of helical form, which interact with an abutment arranged on the underside of the cylinder device. The cylinder lawn mower is advantageous in that it produces a distinct cut which is gentle on the cut grass. A major disadvantage of the cylinder lawn mower, however, is that it is a relatively troublesome procedure to sharpen the blades and then to readjust the blades in relation to the abutment. The cylinder lawn mower also has a tendency to become overloaded when the grass to be cut is long. Another problem is that the cut grass is not finely distributed and as a result is clearly visible on the mown lawn. The cylinder lawn mower is often used when high demands are placed on an even cutting height and gentle cutting of the grass.

A second type is normally referred to as a flail mower. A lawn mower of this kind exhibits a rotatable shaft, which supports blades or flails via an arrangement. The arrangement can be articulated or fixed. Such a lawn mower of the flail mower type is described in U.S. Pat. No. 2,509,343 and comprises blades that are arranged on a rotatable shaft. Each blade tapers in the direction of its two opposing ends, and each end forms an angled cutter. The blades are mounted on the shaft back-to-back in pairs. These are arranged alternately in pairs in three different angled positions, and the angled cutters are thus arranged in six different rows. The cutters are angled towards the blade at an angle of approx. 60°. A flail mower is often used when a high cutting capacity is required and the cutting quality is less important.

There is therefore a need for a device for mowing which exhibits both high cutting quality and high cutting capacity.

### SUMMARY OF THE INVENTION

In light of the above, one object of the present invention is to make available an improved device for mowing.

A further object is to make available a device which permits mowing with high cutting quality.

High cutting quality in this context denotes the achievement of at least one of the following: even cutting height, distinct cutting areas, cutting into finer pieces of the mowings and assimilation of these down into the mown lawn. If the mowing is carried out with high quality, it will thus be possible to obtain a relatively clean mown surface with an even cutting height in a way that is gentle on the grass.

Yet another object is to make available a device of this kind which permits mowing with high capacity.

In order to achieve at least some of the above objects, as well as other objects that will become apparent from the following description, a device for mowing having the distinctive features indicated in claim 1 is proposed in accordance with the present invention. Embodiments of the device can be appreciated from claims 2-15 which are dependent on claim 1.

More precisely, proposed in accordance with the present invention is a device for mowing, comprising a rotatable shaft and a plurality of supporting structures arranged along the shaft, each of which supports a plurality of circumferentially distributed and radially extending blades, each of which exhibits a radially extending blade edge which extends to a free blade end, and which, on rotation of the aforementioned shaft, are arranged for mowing, each blade edge being angled in relation to a blade plane extending perpendicularly to the aforementioned shaft at an angle α of less than 45°, and the free blade ends of the blades in each of the aforementioned supporting structures being divided between at least three mutually separated blade positions in the axial direction.

An improved device, which permits mowing with high cutting quality, is obtained in this way.

The term “radially extending” denotes an extension which comprises a component in the radial direction. Given that the blade edges are angled at the angle α relative to the aforementioned blade plane, these will thus exhibit an extent which also comprises a component in the axial direction.

Thanks to the fact that the blade edges are angled towards the blade plane at an angle α of less than 45°, a raking effect is produced in the blades, which raking effect on the one hand provides orientation and thus ensures the uniform cutting of the grass, and on the other hand effects the assimilation of cuttings down into the lawn from its surface.

The relatively acute angle α also makes it possible to ensure that the blades of the device perform mowing by so-called point cutting, which means that only a radially external section of the respective blade edge engages with the grass during mowing. By providing a plurality of blades per unit of length in the axial direction, it is possible to ensure that the blades produce an essentially even cut surface.

The fact that the blades are radially extending, and that the blade edges are angled at an angle of less than 45°, ensures that the blades are kept clean from clippings during use under the influence of centrifugal force.

The free blade ends of the blades in each of the aforementioned supporting structures are distributed between at least three mutually separated blade positions in the axial direction. This makes it possible, with a relatively small number of supporting structures, to provide the number of blade positions required to obtain an even cutting height. One effect of this is that a cylinder unit formed by the shaft and the supporting structures can be made relatively non-compact or spacious. A cylinder unit that is configured in this way can be made to generate a relatively mild or low fan effect during use, which to a small extent causes uncut grass to be blown out of the way in conjunction with the cutting thereof.

According to one embodiment, each blade edge may extend at an acute angle β to an edge plane which is defined by the extension of the blade in the radial direction and the extension of the shaft in the axial direction. The blade edge of the respective blade may in this case be angled away from the edge plane in a direction opposite to a direction of rotation of the shaft. Thanks to the angling of the blade edge in relation to the edge plane, the self-cleaning properties of the blade are strengthened during use under the effect of centrifugal force.

According to another embodiment of the present invention, the free blade ends of the blades may be arranged at a uniform distance from the rotatable shaft. The achievement of an even cut surface is promoted in this way.

According to yet another embodiment, the supporting structures may be arranged in supporting structure positions, each pair of adjacent supporting structures exhibiting blade positions situated in the axial direction between the pair's supporting structure positions. Each supporting structure in this case may exhibit an identical number of blade positions on the respective side of the associated supporting structure position. Balancing of the supporting structure is facilitated in this way.

According to another embodiment of the present invention, each pair of adjacent supporting structures may share at least one blade position. The achievement of an even cutting height is facilitated in this way because it is easier to minimize variations in the cutting height across a working width of the device.

According to a further embodiment, two supporting structures which are arranged on either side of an intermediate supporting structure may share a single blade position. This blade position may be arranged directly below the intermediate supporting structure, which, according to this embodiment, does not need to be arranged to permit cutting directly below its own supporting structure position.

According to yet another embodiment, the blade positions of the supporting structures may be evenly distributed in the axial direction. The achievement of an essentially even cutting height is promoted in this way. Two adjacent blade positions may be separated in this case by a distance of less than 10 mm.

According to yet another embodiment, the supporting structures may be arranged in supporting structure positions which are evenly distributed in the axial direction.

According to yet another embodiment, two adjacent supporting structure positions may be separated by a distance which is greater than a distance which separates two adjacent blade positions. It is possible in this way to achieve a relatively spacious structure in a cylinder unit formed by the shaft and the supporting structures.

According to a further embodiment, the aforementioned blades may form a plurality of groups of blades, in which blades belonging to the same blade group are supported by separate supporting structures and are arranged along a helically shaped path around the aforementioned shaft. In this way, each blade group can be said to form a discontinuous blade element which resembles a continuous and helically shaped extended blade in a conventional cylinder lawn mower. The helically shaped path for the respective blade group may extend in this case for less than half a turn around the aforementioned shaft. The helically shaped paths of the blade groups can also be evenly distributed circumferentially, which results in an even loading during use.

According to one embodiment, adjacent blades in the respective blade group may be arranged in a relationship that is not overlapping in the axial direction. Given that each supporting structure supports a plurality of blades, it is nevertheless possible to achieve an even cutting height without bare spots.

According to a further embodiment of the present invention, the angle α at which the respective blade edge is angled towards the blade plane can be in the interval 20-40°.

According to yet a further embodiment, the aforementioned supporting structures may be configured as discs which along their periphery support the aforementioned plurality of circumferentially distributed blades. A supporting structure with blades is achieved in this way which is suitable for series production at a relatively low cost. Each blade in this case can be executed in a single piece with the associated disc, which can exhibit a thickness in the interval 0.5-3 mm.

According to yet a further embodiment, the aforementioned supporting structures may be manufactured from a metallic material, a polymer material or a ceramic material.

According to a further embodiment, the device according to the invention may also comprise a bar which is arranged parallel to the aforementioned shaft and is arranged at a distance from the aforementioned supporting structures on an underside of these. The bar has a positive effect on the cutting quality thanks to the fact that the bar can be made to prevent deflection of the grass in conjunction with the cutting thereof, which ensures that the grass is not able to avoid being cut and in addition promotes the uniform cutting thereof. Furthermore, the bar can be made to act as a guard for the blades in order to protect the blades from making contact with the ground because of unevenness of the ground. The distance between the bar and the supporting structures can be 1-2 mm, and the bar can be arranged below the aforementioned supporting structures in a position which lies in an interval corresponding to about 5 o'clock-7 o'clock. The closer to 7 o'clock the bar is arranged, the more effective the protection against ground contact will be.

According to a further embodiment, the following variables have been selected so that the device during use operates at a cutting height which varies from 0-5 mm in the vertical sense:
Diameter of the cylinder unit (Ø)
Number of blades per supporting structure (Nₖ)
Angle at which the blade edge is angled (α)
Number of supporting structures per unit of length (Nₛₚ)
Number of blade positions per unit of length (Nₖₚ)
Peripheral speed of the blade edges (Nₖₚ)
Rotation per unit of length for the respective blade group (γ).

According to yet a further embodiment, each blade may be removably arranged on the respective supporting structure.

According to another embodiment, the device according to the invention may comprise a cover which partially encloses the supporting structures and which, during mowing, is arranged to permit the discharge of cut grass in a direction of advance of the device. Further processing of the cut grass is permitted in this way, as is the assimilation thereof down into the lawn thanks to the raking effect produced by the blades.

The cover may be connected to the aforementioned bar structure.

According to yet a further embodiment, the aforementioned supporting structures may be removably arranged on the aforementioned shaft. A supporting structure can be replaced easily in this way, should the need arise.

According to yet a further embodiment, each pair of adjacent supporting structures may be separated by means of a spacer supported by the aforementioned shaft.

According to yet a further embodiment, at least one of the aforementioned blades may exhibit a twist for the purpose of achieving a fan impeller or blade-like configuration. The fan effect obtained in the device according to the invention during use can be adapted in this way, for example in order to obtain a desired discharge of cut grass.

The terms used in the claims must generally be interpreted in accordance with their normal meaning within the technical field, unless expressly stated to the contrary. All references to “one/the [element, device, component, means, step]” shall be interpreted openly as a reference to at least one occurrence of the aforementioned element, device, component, means, step, etc., unless expressly stated to the contrary. The steps in any of the methods described here do not need to be performed in exactly the described sequence, unless expressly stated to the contrary.

### BRIEF DESCRIPTION OF THE DRAWINGS

The foregoing, as well as additional objects, distinctive features and advantages of the present invention, will be better understood from the following illustrative and non-restrictive detailed description of embodiments of the present invention with reference to the accompanying drawings, where the same reference designations are used for similar elements.

FIG. 1 depicts a perspective view of a first embodiment of a device according to the invention for mowing.

FIG. 2 depicts a perspective view of a cylinder unit for the device for mowing depicted in FIG. 1.

FIG. 3a depicts a side view of a supporting structure for a second embodiment of a device according to the invention.

FIG. 3b depicts a plan view of the supporting structure depicted in FIG. 3a.

FIG. 4 depicts a plan view of a cylinder unit for the second embodiment of the device.

FIG. 5 depicts a schematic side view of a pair of supporting structures and the cutting height variation interval defined by their blades,

FIG. 6 depicts a schematic side view of the second embodiment of the device in use.

FIG. 7a depicts a perspective view of a supporting structure for a third embodiment of a device according to the invention.

FIG. 7b depicts a perspective view in isolation of a blade in the supporting structure in FIG. 7a.

FIG. 7c depicts a plan view of the blade depicted in FIG. 7b.

FIG. 8a depicts a side view of a supporting structure for a fourth embodiment of a device according to the invention.

FIG. 8b depicts a plan view of the supporting structure depicted in FIG. 8a.

FIG. 9a depicts a schematic plan view of a set of supporting structures of the type depicted in FIG. 8a, the set of supporting structures being arranged in a configuration where adjacent supporting structures share intermediate blade positions.

FIG. 9b depicts a schematic plan view of a set of supporting structures of the type depicted in FIG. 8a, the set of supporting structures being arranged in a configuration in which adjacent supporting structures exhibit unique intermediate blade positions.

### DESCRIPTION OF ILLUSTRATIVE EMBODIMENTS

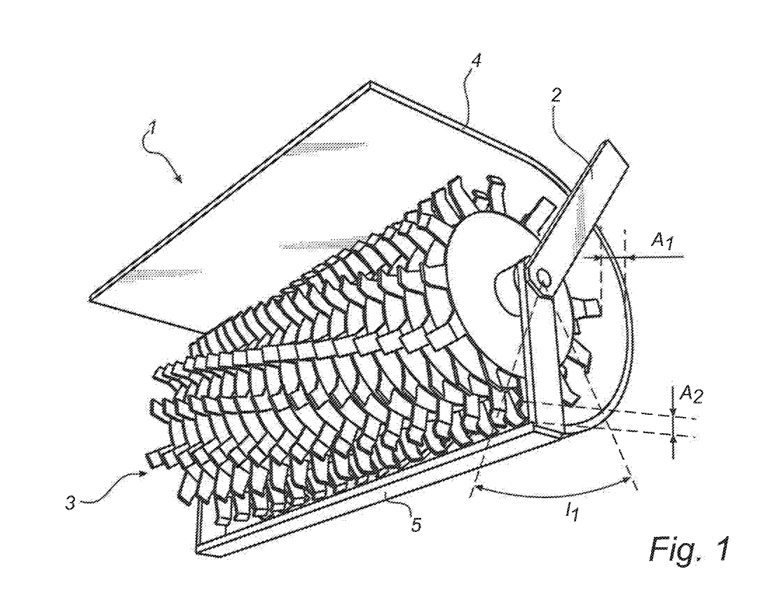

A first embodiment of a device 1 for cutting grass, or mowing, in accordance with the present invention is illustrated with reference to FIG. 1.

Grass is used in this context to denote all the vegetation present on a substrate, the height of which vegetation is to be reduced by mowing.

Mowing is used in this context to denote the removal of parts of plants above a given cutting height in the vegetation present on the substrate. More precisely, the aforementioned parts of plants are removed by imparting a rotational movement to blades in the device 1 according to the invention, causing them to make contact with the grass and, in so doing, to remove the aforementioned plant parts from the grass, where appropriate in association with a bar which endeavours to make the grass stand upright at the moment of cutting.

The depicted first embodiment of the device 1 is carried by a supporting arrangement 2 and comprises a cylinder unit 3, a cover 4 and a bar 5.

The design of the supporting arrangement 2 is not of relevance to the present invention and will accordingly not be described in detail here.

The cover 4 partially encloses the aforementioned cylinder unit 3 and is arranged to permit the discharge of cut grass in the direction of advance of the device 1 during use of the device 1 according to the invention. The cover 4 is thus arranged at a radial distance A₁ from the periphery of the cylinder unit 3, from a position below to a position above the cylinder unit 3, from where the cover 4 extends in an essentially tangential direction. The distance A₁ between the cover 4 and the periphery of the cylinder unit 3 is adapted so that a gap is produced which permits the required discharge of cut grass and may lie in the interval 10-30 mm.

In the position below the cylinder unit, the cover 4 is attached to the aforementioned bar 5, which extends parallel to the cylinder unit 3 at a radial distance A₂ from it.

The position of the bar 5 below the cylinder unit 3 can be arranged in an interval I₁ corresponding to about 5 o'clock-7 o'clock.

The distance A₂ between the bar and the periphery of the cylinder unit 3 ensures that contact between the cylinder unit 3 and the bar 5 is avoided, although at the same time it can be selected so that it is as small as possible. The distance A₂ can thus be dependent on the structural integrity of the cylinder unit 3 and the bar 5 and may be 1-15 mm.

The cover 4 and the bar 5 constitute advantageous adaptations of the device 1 according to the invention. The cover 4 acts partly as a guard to prevent objects, such as twigs and stones, from being hurled towards an operator of the device 1 during use. Given that the cover 4 in the illustrated embodiment allows the discharge of cut grass in the direction of advance, repeated processing and thus additional cutting into finer pieces of the cut grass is permitted. The bar 5 is advantageous in the sense that it prevents deflection of the grass in conjunction with the cutting thereof, which is described in greater detail below.

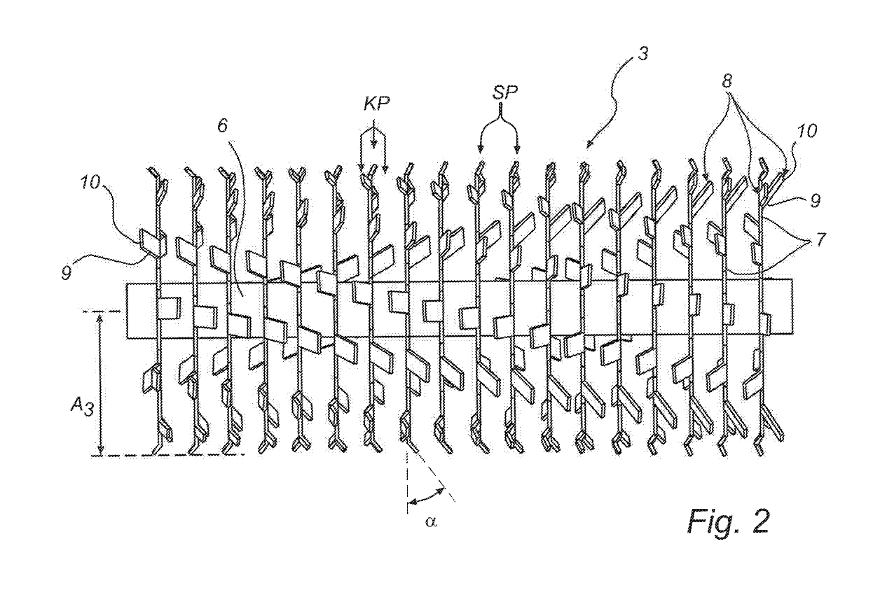

The cylinder unit 3, which is illustrated more clearly in FIG. 2, to which reference is now also made, comprises a shaft 6 and a plurality of supporting structures 7 supported along the same. The shaft 6 is rotatable by means of a drive arrangement (not illustrated), which can comprise an electric motor or an internal combustion engine.

In the depicted first embodiment, the supporting structures 7 are evenly distributed along the shaft 6 in unique supporting structure positions SP for each supporting structure.

The supporting structures 7 can be removably arranged on the shaft 6 and in this case can be mutually separated by means of separate spacers which are passed onto the shaft (not illustrated).

The cylinder unit 3 comprises means for locking the respective supporting structure 7 in the desired angular position on the shaft 6. This means may comprise a polygonal hole in the supporting structure 6 and a corresponding polygonal section in the shaft 6. Alternatively, the arrangement with wedges, pins, locking nuts or similar may be used.

Each supporting structure 7 supports a plurality of projections or blades 8 distributed circumferentially and extending radially, each of which exhibits a radially extending blade edge 9 which extends to the free blade end 10 and which, in conjunction with the rotation of the aforementioned shaft 6, are arranged for mowing.

That the blade edge 9 is radially extended is intended to indicate that the extension of the blade edge 9 comprises a component in the radial direction.

Mowing can be said to be “abutment-free” in the sense that the blades 8 are arranged for the aforementioned mowing without making contact with an abutment, unlike a cylinder lawn mower, in which the blade makes contact with an abutment in order to produce a scissor-like cutting action.

Each supporting structure 7 thus supports a plurality of circumferentially distributed blades 8. It will be appreciated that the number of blades 8 can be varied as required, and each supporting structure 7 comprises twelve blades 8 in the illustrated embodiment.

It will also be appreciated that the supporting structures 7 can be executed in a large number of different ways, and in the illustrated embodiment each supporting structure 7 consists of a disc in which the blades 8 are formed by radially extending projections which are executed in a single piece with the disc.

Each blade edge 9 is angled in relation to a blade plane extending perpendicular to the shaft 6 at an angle α which is less than 45°. In accordance with a presently preferred embodiment, the angle α lies in the interval 20-40° and may be between 25° and 35° in this case.

The blades 8 are so arranged that the free blade ends 10 are arranged at a uniform distance A₃ from the shaft. The achievement of an even cutting height during mowing is promoted in this way.

The free blade ends 10 of the blades 8 in each of the aforementioned supporting structures 7 are also distributed between at least three blade positions KP that are mutually separated in the axial direction. In the illustrated embodiment, the free blade ends 10 in each supporting structure 7 are distributed between eleven blade positions KP, where a free blade end 10 is arranged in each blade position KP apart from the one directly below the supporting structure 7, where two free blade-ends 10 are arranged.

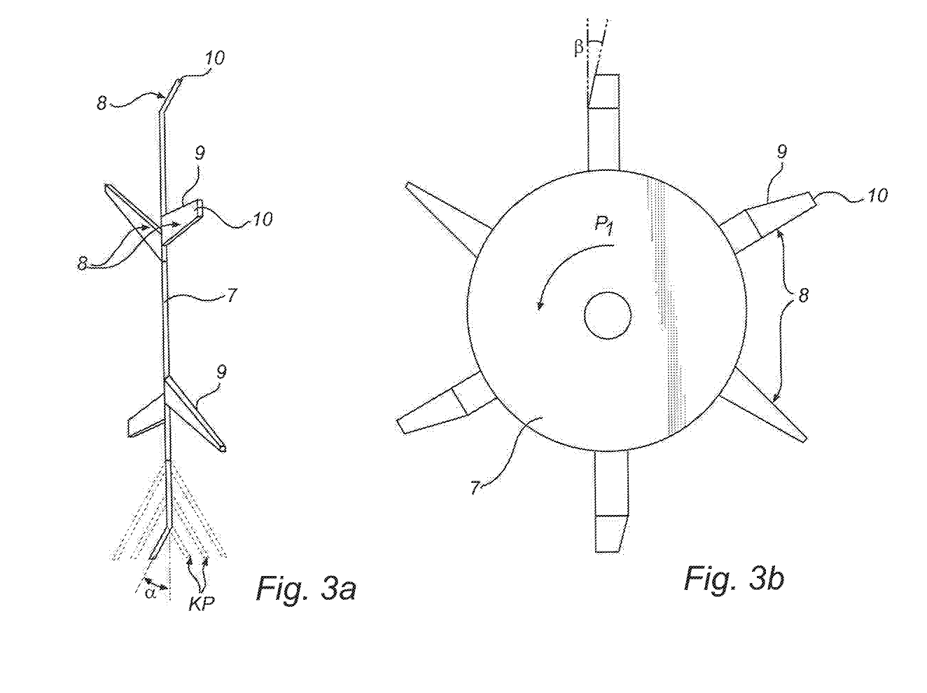

The design of a supporting structure 7 and the blades 8 supported by it are described in more detail below with reference to FIGS. 3a and 3b, which illustrate a supporting structure 7 with six blades 8 for a second embodiment of the device 1 according to the invention.

The supporting structure 7 in this case is configured in the form of a disc having six circumferentially evenly distributed projections, which form the six blades 8 with associated blade edges 9 and free blade ends 10.

More precisely, the projections or the blades 8 in the illustrated embodiment are angled in relation to the disc at a uniform angle but at different radial distances and in different directions. This uniform angle corresponds to the angle α at which the respective blade edge 10 is angled in relation to the aforementioned blade plane. Angle α can be seen clearly in FIG. 3a. It will be appreciated that the angle α does not need to be uniform, but that it is sufficient for the angle α for each individual blade edge 9 to be less than 45. For manufacturing reasons and in order to guarantee an even cutting height for the device 1 according to the invention, however, it may be advantageous to let the angle α be the same for all the blade edges 9.

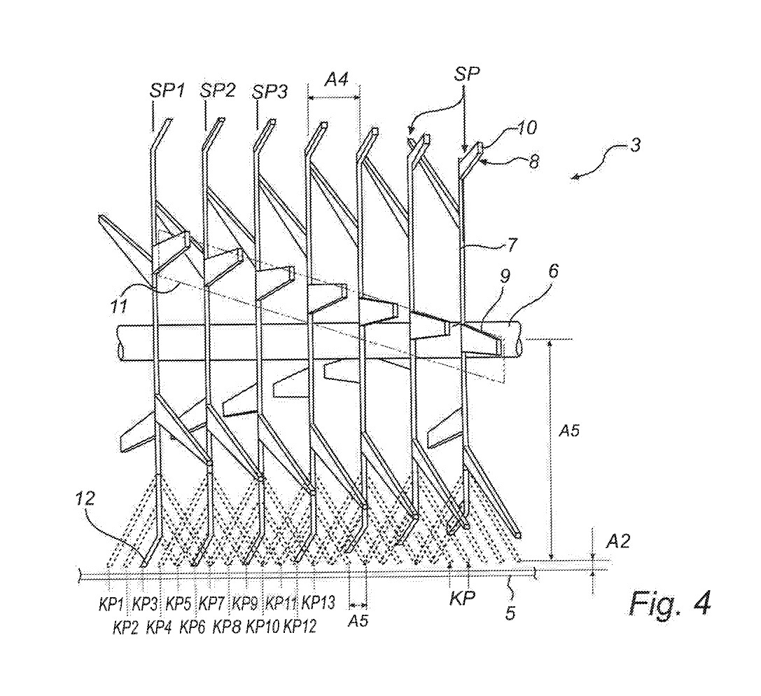

Thanks to the fact that the blades 8 are angled at different radial distances and in different directions, the six free blade ends 10 of the supporting structures 7 are distributed between six blade positions KP, which is explained below in more detail with reference to FIG. 4. It will be appreciated that, if the blade edges 9 are angled at mutually different angles α, the different blade positions KP could be produced by angling at one and the same radial distance.

In the illustrated embodiment, furthermore, each blade edge 9 is angled with an acute angle β in relation to an edge plane defined by the extension of an associated blade 8 in the radial direction and the extension of the shaft in the axial direction, as can be clearly seen in FIG. 3b. More precisely, the blade edge 9 is back-swept, which denotes that the blade edges 9 are angled at the angle δ in a direction opposite a rotational direction for the shaft 6 indicated by the arrow P₁. The angle β can lie in the interval 5-30°.

It will be appreciated that the supporting structures 7 can be designed in a number of different ways. A supporting structure 7 can thus be configured in the form of a disk in accordance with what is described above.

The supporting structure 7 in the form of a disc can exhibit a thickness in the interval 0.5-3 mm.

Alternatively, the supporting structure can be configured in the form of a spindle with a hub which supports a peripheral rim by means of spokes, which peripheral rim in turn supports the aforementioned blades.

The supporting structure can be manufactured from any material which satisfies the necessary requirements with regard to its strength. For example, the supporting structure can be manufactured from a metallic material, a polymer material or a ceramic material.

The blades can be manufactured from the same material as the supporting structure or alternatively from a material that is different from it.

The blades can be manufactured in a single piece with the supporting structure or can be manufactured separately in relation to the supporting structure. In the event that the blades are separately manufactured, these can be arranged interchangeably on the supporting structure.

Illustrated in FIG. 4, to which reference is now made, is a cylinder unit 3 for the aforementioned second embodiment of the device 1 according to the invention, which cylinder unit 4 comprises a plurality of supporting structures 7 or discs of the type described above with reference to FIG. 3a and FIG. 3b supported by a shaft 6.

Also apparent in the Figure is the bar 5 which is arranged below the cylinder unit 3 at a radial distance A₂ from its periphery.

The orientation of the blades 8 in a lower end position, corresponding to 6 o'clock, is indicated by means of broken lines in order to illustrate the positions KP of the blades, between which the free blade ends 10 of the blades 8 are distributed. The blade positions KP for three of the supporting structures 7 are indicated as KP₁-KP₁₃ and the positions SP of the supporting structure for the actual supporting structures 7 are indicated as SP₁-SP₃.

The positions SP of the supporting structure may be evenly distributed in the axial direction, as in the illustrated embodiment. As a non-restrictive example, each pair of adjacent supporting structures 7 in this case may be separated by a distance A₄ which is in the interval 20-40 mm.

As in the illustrated embodiment, each supporting structure 7 may exhibit blade positions KP arranged on both sides of its supporting structure position SP.

Each supporting structure 7 may also exhibit an identical number of blade positions KP on the respective side of the position SP of the supporting structure. In the illustrated embodiment, three blade positions KP are arranged on the respective side, which can be illustrated with the help of the supporting structure 7 in supporting structure position SP₂, which supporting structure 7 exhibits blade positions KP₄-KP₆ on one side and blade positions KP₈-KP₁₀ on the other side.

Each pair of adjacent supporting structures 7 exhibits blade positions KP situated in the axial direction between the supporting structure positions SP of the supporting structures 7. In the illustrated embodiment, each such pair exhibits two intermediate blade positions KP, which can be exemplified with the help of the pair of supporting structures 7 situated in the supporting structure positions SP₁ and SP₂, which between them exhibit the blade positions KP₅ and KP₆.

In addition, each pair of adjacent supporting structures 7 can share at least one blade position KP. In the illustrated embodiment, for example, the pair of supporting structures 7 in the supporting structure positions SP₁ and SP₂ shares the blade positions KP₅ and KP₆.

Two supporting structures 7, which are arranged on either side of an intermediate supporting structure 7, may also share a blade position KP, which can be illustrated, for example, with the help of the supporting structures 7 in the supporting structure positions SP₁ and SP₃, which share blade position KP₇, arranged on either side of the supporting structure 7 in supporting structure position SP₂.

The blade positions KP may be evenly distributed in the axial direction, as in the illustrated embodiment.

Two adjacent blade positions KP can be mutually separated by a distance A₅ which is less than 10 mm. As can be appreciated from FIG. 4, the distance A₄ between two adjacent supporting structure positions SP is greater than the distance A₅ between two adjacent blade positions KP.

As can be appreciated from FIG. 4, the supporting structures 7 are mutually twisted so that the blades 8 form a plurality of blade groups 11 where blades 8 belonging to the same blade group 11 are supported by separate supporting structures 7 and are arranged along a helically shaped path in the axial direction. The twist may be less than half a turn along the extent of the shaft 6. According to a non-restrictive example, the twist in the circumferential sense can be 120° per meter.

The helically shaped paths of the blade groups 11 may be evenly distributed circumferentially, as shown in the illustrated embodiment.

As can be appreciated from the depicted embodiment, adjacent blades 8 in the respective blade group 11 are arranged in a non-overlapping relationship in the axial direction.

The fact that the blades 8 are angled at an angle α which is less than 45° and are in addition angled in opposite directions, permits point cutting to be achieved, which denotes that cutting takes place essentially along a radially outer section of the respective blade edge. The section along which cutting takes place is marked as 12 in FIG. 4.

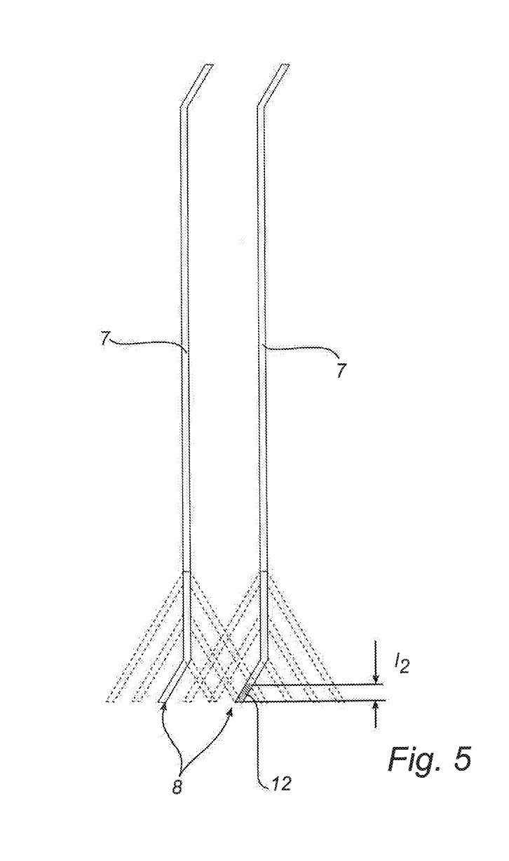

In FIG. 5, to which reference is now also made, a pair of supporting structures is illustrated schematically, where the orientation of the blades 8 in the lower end position is marked by means of broken lines. A radially outer section of a blade edge 9 is marked as 12. It can be appreciated from the Figure how the radially outer sections 12 define a cutting height variation interval I₂, and it can be seen that this cutting height variation interval I₂ can be modified by adaptation of the mutual distance A₅ between the blade positions KP and the angle α of the blade edges 9.

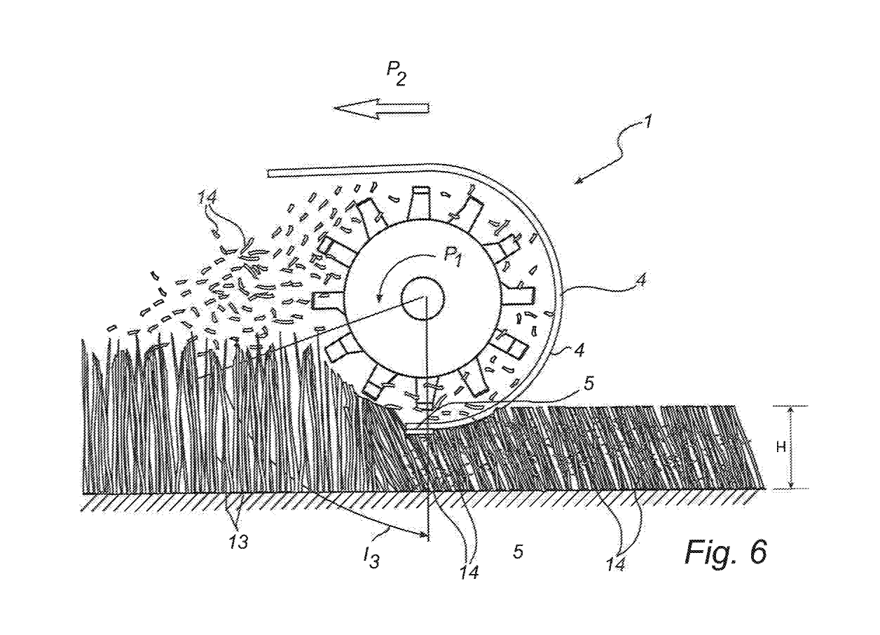

The second embodiment of the device 1 according to the invention during use is now also described below with reference to FIG. 6, which schematically illustrates the device 1 when it is displaced in a direction of advance over a lawn indicated by the arrow P₂.

The shaft 6 of the cylinder unit 3 is caused to rotate by means of the drive arrangement (not illustrated) in a direction of rotation indicated by the arrow P₁. The rotation in this case is adapted so that the blade edges 9 of the blades 8 face in the direction of rotation P₁.

The speed with which the shaft 6 rotates is adapted so that a required peripheral speed of the blades 8 is achieved. The required peripheral speed can be selected, for example, so that it is dependent on the speed of rotation of the shaft 9, the mass or diameter of the cylinder unit 3, the width of the blades 8 and/or the width, sharpness, angle α or angle β of the blade edges 9.

Upon rotation of the shaft 6, the blades 8 and their blade edges 9 of the supporting structures 7 will be brought into contact with the uncut grass 13. On condition that an adequate speed is imparted to the blades 8, the blade edges 9 will now engage with the grass 13 and cut or chop it down.

The blades 8 of the supporting structure 7 are effective within a cutting interval which is marked with I₃ and perform successive cutting of the grass 13 down to the actual cutting height, which essentially corresponds to the height above the ground which the free blade ends 10 of the blades 8 adopt when they are in their lower end position, and which is marked with H in the Figure.

A certain variation in the cutting height H will occur, among other things as a consequence of the cutting height variation interval I₂ described above. This cutting height variation interval I₂ can be made to be essentially negligible, however, by the appropriate choice of the angle α and the distance A₅ between the blade positions KP.

The interval I₃ below which the blades 8 are active for mowing is dependent on the diameter of the cylinder unit 3 and the height of the grass 13 to be cut and the position of the bar 5 under the cylinder unit 3.

The fact that the blade edges 9 are angled at an angle α which is less than 45′ also means that the blades produce a raking effect, by which the grass 13 is oriented to permit uniform cutting thereof.

The bar 5, which is arranged below the cylinder unit 3, prevents bending of the grass 13 in conjunction with cutting thereof. Given that the bar 5 endeavours to maintain the grass 13 upright, the result is uniform cutting thereof.

Uniform cutting of the grass 13 denotes that essentially equally sized pieces of the grass 13 are cut from the respective blades of grass in the course of the successive cutting down to the final cutting height H.

A fan effect is obtained in conjunction with rotation of the cylinder unit 3, and the cover 4 which partially encloses the cylinder unit 3 endeavours to direct a flow of air produced by the aforementioned fan effect so that this carries along cut grass, referred to below as clippings 14, and discharges it in the direction of advance P₂, in front of the device 1 according to the invention. The clippings 14 in this case land on the surface of the uncut lawn. This permits repeated processing of the clippings 14 for the purpose of their further cutting into finer pieces.

Thanks to the fact that the blade edges 9 exhibit a radial extent, centrifugal force will endeavour to remove clippings 14 from the blades 8. The self-cleaning properties of the blades 8 are improved if the blade edges 9 are back-swept at an angle β, as shown in the illustrated embodiment.

The fact that the clippings 14 are deposited in front of the device 1 according to the invention, in combination with the raking effect which the blades 8 produce, also means that the device 1 according to the invention endeavours to assimilate the clippings 14 down into the mown lawn.

As already mentioned, the bar 5 interacts with the blades 8 as they cut the grass 13. In addition, the bar 5 acts as a guard for the cylinder unit 3 and prevents the blades 8 of the cylinder unit 3 from striking the ground or objects such as stones. In the event that the device 1 according to the invention is intended for cutting grass on an uneven substrate, such as a bumpy lawn, it may be advantageous to arrange the bar 5 below the cylinder unit 3 in a forward position, which can essentially correspond to 7 o'clock. In the case that the device 1 is intended for cutting on an even substrate with high requirements for an even cutting height H, it may be advantageous to arrange the bar 5 in a rearward position which essentially corresponds to 5 o'clock.

The device 1 according to the invention permits mowing with high cutting quality.

High cutting quality is used in this context to denote the achievement of a relatively clean mown surface with an even cutting height in a manner that is gentle on the grass.

The relatively acute angle α at which the respective blade edge 9 is angled in relation to the blade plane ensures that the blades 8 perform cutting by means of point cutting. In this case, the radially outer section 12 of the respective blade edge 9, which outer section 12 engages with the grass 13 for mowing, can be minimized by the adaptation of the number of blade positions KP per supporting structure 7 and by the adaptation of the mutual distance A₅ between two adjacent blade positions KP. All in all, this means that an even cutting height H can be obtained.

The fact that each blade 8 performs point cutting and in addition exhibits a blade edge 9 ensures that the blades 8 produce a distinct cut surface which is gentle on the individual blades of grass.

Thanks to the fact that each supporting structure 7 supports blades which are effective in a large number of blade positions KP, it is possible to achieve relatively closely arranged blade positions KP with a relatively small number of supporting structures 7. The cutting height variation interval I₂, which is defined by the radially outer sections 12 of the blade edges 9, can be minimized in this way, while the cylinder unit 3 remains relatively non-compact or spacious. It is possible in this way to reduce the fan effect generated during use, which produces a positive influence on the cutting action through the ability to minimize any influence of blowing uncut grass 13 out of the way produced by the aforementioned fan effect.

Thanks to the fact that the blades 8 are arranged in blade groups 11, each of which extends along a helically shaped path around the shaft 9, a discontinuous and helically shaped extended blade element is obtained, which ensures that the blades 8 are in engagement with the grass 13 at essentially any given time during use, which permits even loading during use.

As a matter of fact, the arrangement of the blade groups 11 in helical form means that the device 1 according to the invention operates rather like a cylinder lawn mower.

A relatively small lateral transport of clippings 14 is achieved by ensuring that the speed of rotation of the helically shaped tracks is relatively moderate.

The bar 5 arranged below the cylinder unit 3 interacts with the blades 8 in the sense that the bar 5 ensures that the grass 13 is not deflected in conjunction with the engagement of the blades 8 with the grass 13, which promotes the uniform cutting of the grass 13. No direct contact between the bar 5 and the blades 8 takes place, however.

The raking effect of the blades 8 also promotes the uniform cutting of the grass 13. The raking effect, in combination with the discharge of clippings 14 in the direction of advance P₂, also makes it possible to convey the clippings 14 effectively down into the lawn.

There is consequently a number of different parameters which influence the performance of the device 1 for mowing according to the invention. The following can be mentioned as nonrestrictive examples of such parameters:
Diameter of the cylinder unit 3 (Ø)
Number of blades 8 per supporting structure 7 (Nₖ)
Angle at which the blade edge 9 is angled (α)
Number of supporting structures 7 per unit of length (Nₛₚ)
Number of blade positions KP per unit of length (Nₖₚ)
Peripheral speed of the blade edges 9 (v)
Twist per unit of length for the respective blade group 11 (γ)

In a practical experiment, a device 1 according to the invention was configured in accordance with the following:

| | |
|---|---|
| Ø | 30 mm |
| Nₖ | 12 pieces |
| α | 28° |
| Nₛₚ | 42 pieces/m |
| Nₖₚ | 200 pieces/m |
| v | 20-40 m/s |
| γ | 120°/m |

A device 1 configured in this way exhibits blade positions KP which are arranged so closely together that a required even cutting height H is obtained while the cylinder unit 3 also exhibits the required spaciousness. For example, it has been established that the fan effect generated during use produces a relatively short discharge of clippings 14 in the direction of advance P₂ for a distance of 30-40 cm.

It will be appreciated that the present invention is not restricted to the embodiments illustrated above.

It is thus possible to omit the subjacent bar and to carry out mowing without a bar being present to hold up the grass as it is being cut.

The cover can also be modified in many different ways, for example to permit discharge in the rearward direction.

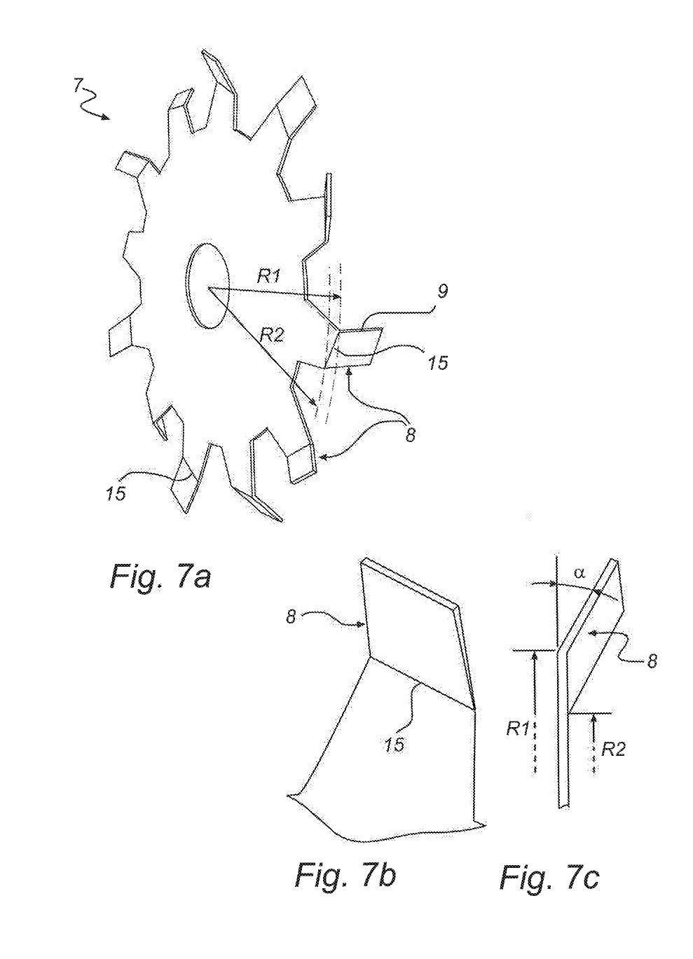

The fan effect of the cylinder unit during use may also be modified in other ways than the adaptation of its compactness. The fan effect may thus also be modified by adaptation of the speed at which the cylinder unit rotates or by adaptation of the size of the gap between the cover and the periphery of the cylinder unit. A further way of modifying the fan effect involves, in one or more of the supporting structures, imparting a twist to one or more of the blades so that these adopt a fan impeller or blade-like configuration, as illustrated in FIGS. 7a-c. More precisely, it can be appreciated how the angled blades 8 also exhibit a twist in order to achieve the aforementioned blade-like configuration. The twist in the illustrated embodiment is achieved by a fold line 15, around which the respective blade 8 is angled in order to provide angling of the blade edge 9 at the angle α, extending in a linear fashion from a starting point at a first radial distance R1 from the centre of the supporting structures 7 to an end point at a second radial distance R2 from the aforementioned centre. This inclination of the fold line 15 in relation to a tangential direction means that the blades 8 receive the desired twist.

It will be appreciated that not all the blades need to be twisted and/or that not all the supporting structures need to have twisted blades. It will also be appreciated that the supporting structures could support fan blades separate from the aforementioned blades in order to permit the adaptation of the fan effect of the cylinder unit. It would also be possible to arrange the fan blades so that they are carried by the shaft separately from the supporting structures.

It is also conceivable to configure the supporting structures in other ways.

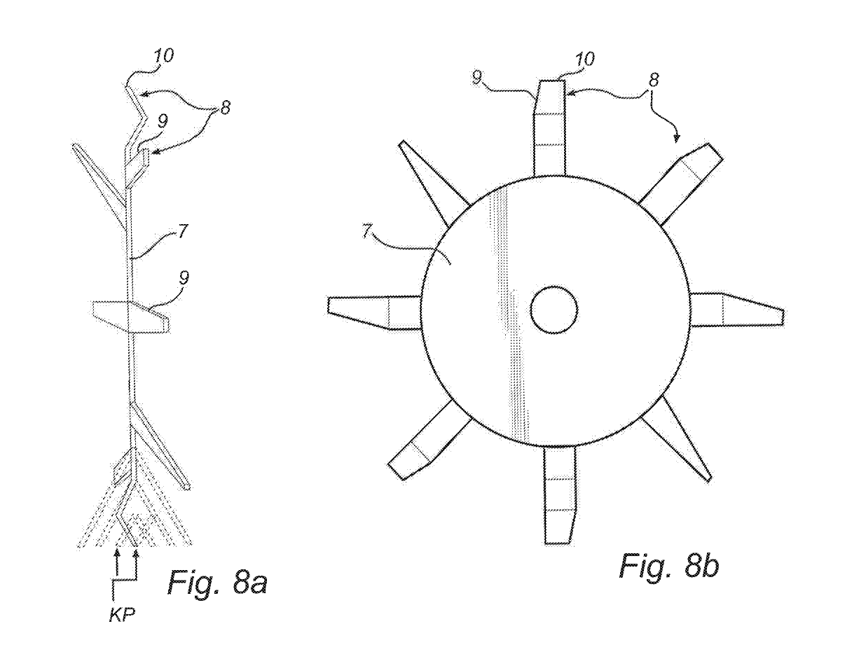

In FIGS. 8a and 8b, to which reference is now made, a supporting structure 7 is illustrated for a fourth embodiment of the present invention, which supporting structure 7 comprises eight projections, each of which exhibits peripherally its own blade 8 with an angled blade edge 9. The blades 8 are evenly distributed circumferentially. The free blade ends 10 of the blades 8 are distributed between seven blade positions KP for the supporting structure 7, which is illustrated by means of broken lines which depict the blades 8 when these adopt a lower end position. Like the supporting structure 7, which is described above with reference to FIG. 4, the supporting structure 7 in this case also exhibits three blade positions KP on each side. In addition, the supporting structure 7 exhibits a blade position KP which coincides with the principal plane of the supporting structure 7. The supporting structure 7 thus comprises blades 8 with the ability to cut directly below the actual supporting structure 7.

It is thus not necessary, as in the second embodiment described above with reference to FIG. 4, to position the supporting structures 7 relative to one another so that two supporting structures 7, which are situated to either side of an intermediate supporting structure 7, share a single blade position KP below the intermediate supporting structure 7, which means that the supporting structures 7 can be arranged more sparsely along the shaft 6, thereby making the cylinder unit 3 even less compact and thus more spacious.

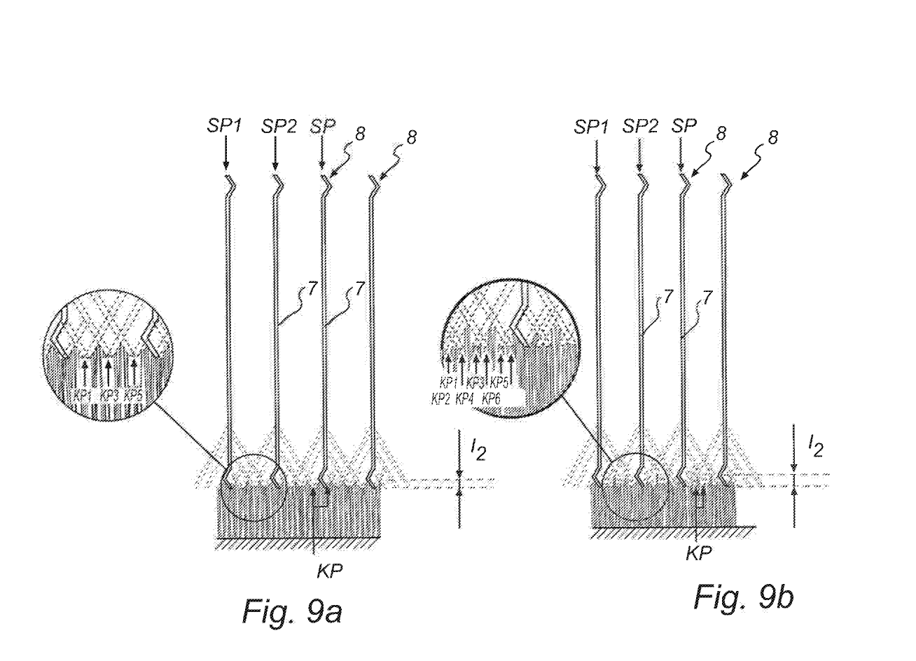

The embodiments of the present invention described above exhibit all the adjacent supporting structures which share intermediate blade positions. It will be appreciated that it is also possible for adjacent supporting structures to exhibit intermediate unique blade positions, as illustrated in FIGS. 9a and 9b.

FIG. 9a exhibits schematically a set of supporting structures 7 of the type described above with reference to FIGS. 8a and 8b. Adjacent supporting structures 7 share intermediate blade positions KP, which can be exemplified with the help of the pair of supporting structures 7 situated in the supporting structure positions SP₁ and SP₂, which between them exhibit the blade positions KP₁, KP₂ and KP₃. This configuration results in a cutting height variation interval I₂ where each tip is equally high.

FIG. 9b also illustrates schematically a set of supporting structures 7 of the type described above with reference to FIGS. 8a and 8b. Adjacent supporting structures 7 in this configuration exhibit intermediate unique blade positions KP, however, which can be exemplified with the help of the pair of supporting structures 7 situated in the supporting structure positions SP₁ and SP₂, which between them exhibit the blade positions KP₂, KP₄ and KP₆ belonging to the supporting structure 7 in supporting structure position SP₁ and the blade positions KP₁, KP₃ and KP₅ belonging to the supporting structure 7 in supporting structure position SP₂. This configuration results in a cutting height variation interval I₂ which is certainly relatively larger than the interval I₂ for the set illustrated in FIG. 9a, however the size of which depends on a smaller number of tips which are higher than other tips. Provided that the blade positions KP are arranged sufficiently close together, however, the highest tips can be cut in adjacent blade positions KP thanks to the ability of the grass to bend, for which reason unique intermediate blade positions KP can result in practice in a relatively more even surface of the cut grass.

Each blade exhibits, in accordance with what is described above, a radially extending blade edge. This blade edge may be formed by a conventional grinding process. Alternatively, a relatively small thickness may be imparted to the blade. If, for example, the blade is manufactured from a steel with a thickness of 1 mm, the unmachined end surface of the blade can act as a blade edge with satisfactory cutting quality. The need for regrinding may also be eliminated because the small thickness ensures that satisfactory cutting quality is maintained even when the blade edge has become worn. A further advantage of manufacturing the blades from a relatively thin material is that the blades can be given the propensity to vibrate during use in this way. These vibrations help to keep the blades free from clippings.

A supporting structure may also be configured so that it exhibits two blades with opposing orientation in the same angular position. This can be achieved, for example, by manufacturing two discs, each of which exhibits blades which are angled only in a single direction. The discs are then assembled back-to-back on the shaft and are mutually oriented so that a single supporting structure is obtained with two blades in the same angular position, but with each facing in its own direction. Supporting structures of this type can be advantageous when a relatively small diameter of the cylinder unit is desirable. In order to maintain the required spaciousness of the device, it may be appropriate in this case to reduce the number of angular positions in the circumferential sense which exhibit blades, and by allowing two blades to share the same blade position, the number of blades can be doubled for a given number of blade positions.

A device for mowing in accordance with the present invention may comprise one or more cylinder units of one of the kinds described above.

The device for mowing according to the invention may be of the ride-on type.

The device according to the invention may be used for conventional mowing, such as mowing of golf courses, lawns and the like, but also for agricultural purposes of different kinds. A load carrier, such as a tractor, which carries one or more cylinder units of the kind described above, is consequently considered, in accordance with the present invention, to constitute a type of device for mowing. It will be appreciated that, for this application, the dimensions of the cylinder unit, such as its length and diameter, can be larger than the dimensions indicated previously.

More modifications and variations are thus possible, for which reason the scope of the invention is defined exclusively by the accompanying claims.

1. Device for mowing, comprising:
a rotatable shaft and
a plurality of supporting structures arranged along the shaft, each of which supports a plurality of circumferentially distributed and radially extending blades, each of which exhibits a radially extending blade edge which extends to a free blade end and which, on rotation of the aforementioned shaft, are arranged for mowing,
each blade edge being angled in relation to a blade plane extending perpendicularly to the aforementioned shaft at an angle which is less than 45°, and
the free blade ends of the blades on each of the aforementioned supporting structures being distributed between at least three blade positions mutually separated in the axial direction.

2. Device for mowing according to claim 1, in which each blade edge extends at an acute angle to an edge plane, which is defined by the extension of an associated blade in the radial direction and the extension of the shaft in the axial direction.

3. Device for mowing according to claim 1, in which the supporting structures are arranged in supporting structure positions, each pair of adjacent supporting structures exhibiting blade positions situated in the axial direction between the pair's supporting structure positions.

4. Device for mowing according to claim 1, in which each supporting structure exhibits an identical number of blade positions on the respective side of the position of the associated supporting structure.

5. Device for mowing according to claim 1, in which each pair of adjacent supporting structures shares at least one blade position.

6. Device for mowing according to claim 1, in which two supporting structures arranged on either side of an intermediate supporting structure share a blade position.

7. Device for mowing according to claim 1, in which the blade positions of the supporting structures are evenly distributed in the axial direction.

8. Device for mowing according to claim 1, in which two adjacent blade positions are separated by a distance of less than 10 mm.

9. Device for mowing according to claim 1, in which the aforementioned supporting structures are arranged in supporting structure positions that are evenly distributed in the axial direction.

10. Device for mowing according to claim 9, in which two adjacent supporting structure positions are separated by a distance which is greater than a distance which separates two adjacent blade positions.

11. Device for mowing according to claim 1, in which the angle at which the respective blade edge is angled towards the blade plane is in the interval of about 20-40°.

12. Device for mowing according to claim 1, in which the aforementioned supporting structures are configured as discs which along their periphery support the aforementioned plurality of circumferentially distributed blades.

13. Device for mowing according to claim 12, in which each disc exhibits a thickness in the interval of about 0.5-3 mm.

14. Device for mowing according to claim 1, further comprising a bar which is arranged parallel to the aforementioned shaft and is arranged at a distance from the aforementioned supporting structures on an underside of these.

15. Device for mowing according to claim 1, in which at least one of the aforementioned blades exhibits a twist for the purpose of achieving a fan impeller or blade-like configuration.

16. Device for mowing according to claim 2, in which the supporting structures are arranged in supporting structure positions, each pair of adjacent supporting structures exhibiting blade positions situated in the axial direction between the pair's supporting structure positions.

17. Device for mowing according to claim 2, in which each supporting structure exhibits an identical number of blade positions on the respective side of the position of the associated supporting structure.

18. Device for mowing according to claim 2, in which each pair of adjacent supporting structures shares at least one blade position.

19. Device for mowing according to claim 2, in which two supporting structures arranged on either side of an intermediate supporting structure share a blade position.

20. Device for mowing according to claim 2, in which the blade positions of the supporting structures are evenly distributed in the axial direction.
